(19) United States
(12) Patent Application Publication
(10) Pub. No.: US 2022/0011836 A1
(43) Pub. Date: Jan. 13, 2022

(54) FLOW ENHANCEMENT STRUCTURE TO INCREASE BANDWIDTH OF A MEMORY MODULE

(71) Applicant: Intel Corporation, Santa Clara, CA (US)

(72) Inventor: Debra BEYER, Hillsboro, OR (US)

(21) Appl. No.: 17/484,409

(22) Filed: Sep. 24, 2021

(51) Int. Cl. G06F 1/20

(52) U.S. Cl. CPC G06F 1/20

(57) ABSTRACT

The bandwidth of a memory module is increased by the addition of flow enhancing structure that extends from the top of the memory module into a memory module channel near a memory chip on the memory module operating at a high temperature. The flow enhancing structure disrupts the airflow at that spot, making the airflow more turbulent and faster, which increases the heat transfer from the memory chip operating at the high temperature. The shape and placement of the flow structure in the memory module channel is selected such that that there is a minimal increase in impedance while also having the maximum heat transfer from the memory module operating at the highest temperature.

### FIELD

This disclosure relates to memory modules and in particular to cooling a memory module in a computer system.

### BACKGROUND

A memory module is a printed circuit board on which memory integrated circuits (“chips”) are mounted to another printed circuit board, such as a motherboard, via a connector (also referred to as a “socket”). The connector is installed on the motherboard and a memory module is inserted into the connector. The connector enables interconnection between a memory module and a circuit on the motherboard. A dual in-line memory module (DIMM) has separate electrical contacts on each side of the memory module.

The DIMM can include dynamic (read/write) memory, a volatile read/write memory in which the cells require the repetitive application of control signals generated inside or outside the integrated circuit to retain stored data. Each repetitive application of the control signals is normally called a refresh operation or cycle.

A refresh time interval is the time interval between the beginnings of successive signals that are intended to restore the level in a dynamic memory cell to its original level. The refresh time interval is determined by the system in which the dynamic memory operates. A maximum value is specified that is the longest interval for which correct operation of the dynamic memory is to be expected.

The maximum time interval between refresh operations is typically in the range of milliseconds for dynamic (read/write) memory, for example, Dynamic Random Access Memory (DRAM) and is dependent on the ratio of charge stored in memory cell capacitors to leakage currents. Leakage currents increase with temperature, so the time interval between refresh operations is decreased as the temperature increases. For example, the time interval between refresh operations is typically decreased by a factor of 2 (that is, the refresh rate is increased) when the temperature of the DRAM exceeds 85° C. (185° F.).

Refresh operations in DRAM consume power and reduce bandwidth for memory access (read/write operations). For example, the increase in power consumption for a 16 Gigabit (Gb) Quad Rank Load Reduced Double Data Rate Dual In-Line Memory Module with synchronous dynamic random access memory (SDRAM) devices that are compatible with memory technologies such as DDR5 (Double Data Rate version 5, originally published in July 2020) when the time interval between refresh operations is decreased by a factor of 2 could be about 5 Watts.

### BRIEF DESCRIPTION OF THE DRAWINGS

Features of embodiments of the claimed subject matter will become apparent as the following detailed description proceeds, and upon reference to the drawings, in which like numerals depict like parts, and in which:

FIG. 1 is a block diagram of a temperature profile of a memory module including a plurality of DRAM chips;

FIG. 2 illustrates a channel between a first memory module and a second memory module in a motherboard in a computer system;

FIG. 3 is a top view of the channel between the first memory module and the second memory module shown in FIG. 2;

FIG. 4 is a side view of a channel structure that includes a horizontal support member and a flow enhancing structure that extends from the top of the memory module into a channel between a first memory module and a second memory module;

FIG. 5 illustrates placement of the channel structure in the channel between the first memory module and the second memory module shown in FIG. 2;

FIG. 6 is a top view of the channel between the first memory module and the second memory module shown in FIG. 2 that includes the flow enhancing structure;

FIG. 7 illustrates another embodiment of channel structure in a system having a plurality of memory modules;

FIG. 8 illustrates a side view of the channel structure 700 shown in FIG. 7;

FIG. 9 is as an end view of the channel structure 700 shown in FIG. 7;

FIG. 10 is a top view of the embodiment of channel structure in a system having a plurality of memory modules shown in FIG. 7; and

FIG. 11 is a block diagram of an embodiment of a computer system that includes a plurality of memory modules.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined as set forth in the accompanying claims.

### DESCRIPTION OF EMBODIMENTS

Cooling is used in a computer system to remove heat produced by components in the computer system, to keep the components within permissible operating temperature limits. A fan is typically used for cooling when natural convection is insufficient to remove heat.

Airflow in a channel between memory modules in a computer system develops such that the temperature gradient from a memory chip (for example, a Dynamic Random Access Memory (DRAM) chip) at one end of the memory module (for example, a Dual Inline Memory Module (DIMM)) to a DRAM chip at the other end of the memory module can be about 13° C. (55° F.). Thus, all DRAM integrated circuits (“chips”) on a DIMM in a computer system do not operate at the same temperature. Some DRAM chips may operate at a low temperature below 85° C. (185° F.) and others may operate between 85° C. (185° F.) and 95° C. (203° F.).

Memory throttling can be used to cool the DRAM chips on the DIMM by reducing the number of memory operations to reduce the power consumed by the DRAM chips, thus reducing thermal output. Memory throttling is typically based on the DRAM chip with the highest temperature on the DIMM.

To reduce memory throttling, a full DIMM heat spreader can be added to the DIMM to remove heat. However, a full DIMM heat spreader becomes ineffective when the impedance due to the full DIMM heat spreader causes sufficient impedance to slow down the airflow.

Another method that can be used to reduce memory throttling is to increase the power of the system fan. Increasing the power of the system fan power increases the cost of the system but does not directly address the problem because the DRAM chips on the DIMM that are closest to the fan are sufficiently cooled prior to increasing the power of the system fan.

A flow enhancing structure that extends from the top of the DIMM into a DIMM channel near the DRAM operating at the highest temperature disrupts the airflow at that spot, making the airflow more turbulent and faster, which increases the heat transfer from the DRAM operating at the highest temperature.

The shape and placement of the flow structure in the DIMM channel is selected such that that there is a minimal increase in impedance while also having the maximum heat transfer from the DRAM operating at the highest temperature.

Increased cooling at the position of the DRAM operating at the highest temperature ensures that the DIMM will perform better and throttle less. The increase in the cooling capability due to the placement of the flow enhancing structure in the DIMM channel also increases the maximum bandwidth to the DIMM because refresh uses less traffic on the data bus and the need for memory throttling is reduced. Increased cooling at the position of the DRAM operating at the highest temperature lowers cooling costs due to the decrease in the power of the system fan power to provide the cooling provided by the flow structure in the DIMM channel.

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

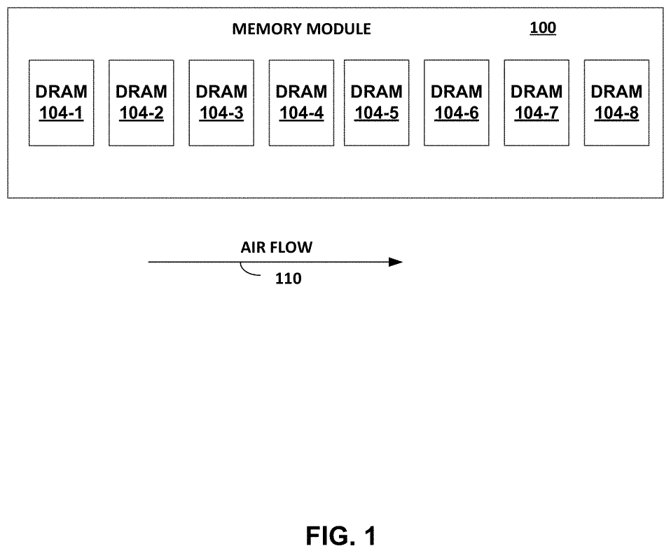

FIG. 1 is a block diagram of a temperature profile of a memory module 100 that includes a plurality of DRAM chips (memory integrated circuits) 104-1, . . . , 104-8. The memory module 100 is a printed circuit board on which the a plurality of DRAM chips 104-1, . . . , 104-8 are mounted.

The direction of the airflow 110 shown in FIG. 1 in a system in which the memory module 100 is operating is from the left of the memory module 100 to the right of the memory module 100. Based on the direction of the airflow 110 in the system in which the memory module 100 is installed, the DRAM chips 104-1, . . . 104-4 at the left of the memory module are cooler than the DRAM chips 104-5, . . . 104-8 at the right side of the memory module 100. In the example shown, the operating temperature of DRAM chip 104-1 at the left of the memory module 100 can be about 74° C. and the operating temperature of DRAM chip 104-8 on the right of the memory module 100 is about 94° C.

Reference to memory devices can apply to different memory types. Memory devices often refers to volatile memory technologies. Volatile memory is memory whose state (and therefore the data stored on it) is indeterminate if power is interrupted to the device. Nonvolatile memory refers to memory whose state is determinate even if power is interrupted to the device. Dynamic volatile memory requires refreshing the data stored in the device to maintain state. One example of dynamic volatile memory includes DRAM (dynamic random access memory), or some variant such as synchronous DRAM (SDRAM). A memory subsystem as described herein may be compatible with a number of memory technologies, such as DDR3 (double data rate version 3, original release by JEDEC (Joint Electronic Device Engineering Council) on Jun. 27, 2007, currently on release 21), DDR4 (DDR version 4, JESD79-4 initial specification published in September 2012 by JEDEC), DDR4E (DDR version 4, extended, currently in discussion by JEDEC), LPDDR3 (low power DDR version 3, JESD209-3B, August 2013 by JEDEC), LPDDR4 (LOW POWER DOUBLE DATA RATE (LPDDR) version 4, JESD209-4, originally published by JEDEC in August 2014), WIO2 (Wide I/O 2 (WideIO2), JESD229-2, originally published by JEDEC in August 2014), HBM (HIGH BANDWIDTH MEMORY DRAM, JESD235, originally published by JEDEC in October 2013), DDR5 (DDR version 5, currently in discussion by JEDEC), LPDDR5 (currently in discussion by JEDEC), HBM2 (HBM version 2), currently in discussion by JEDEC), or others or combinations of memory technologies, and technologies based on derivatives or extensions of such specifications.

Descriptions herein referring to a “RAM” or “RAM device” can apply to any memory device that allows random access, whether volatile or nonvolatile. Descriptions referring to a “DRAM” or a “DRAM device” can refer to a volatile random access memory device. The memory device or DRAM can refer to the die itself, to a packaged memory product that includes one or more dies, or both. In one embodiment, a system with volatile memory that needs to be refreshed can also include nonvolatile memory.

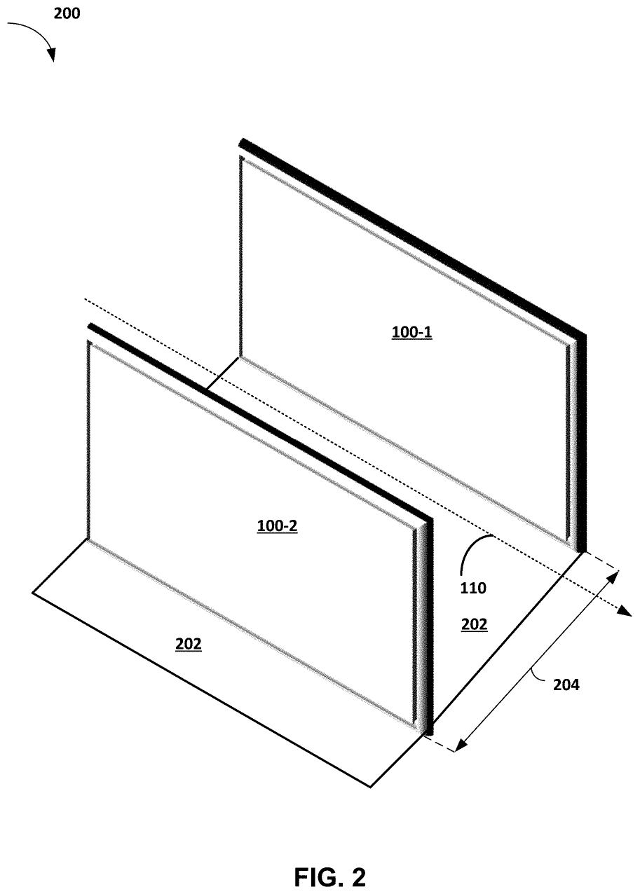

FIG. 2 illustrates a channel 204 between a first memory module 100-1 and a second memory module 100-2 in a motherboard 202 in a computer system 200. The channel 204 is the space between two memory modules (the first memory module 100-1 and the second memory module 100-2). The two memory modules can be dual in-line memory modules (DIMM)s.

As discussed in conjunction with FIG. 1, each of the memory modules 100-1, 100-2 is a printed circuit board on which memory integrated circuits (“chips”) are mounted. The first memory module 100-1 and the second memory module 100-2 are coupled to a motherboard 202 (another printed circuit board), via connectors (also referred to as a “socket”). The connectors are installed on the motherboard 202 and each of the first memory module 100-1 and the second memory module 100-2 is inserted into a respective connector. Each of the connectors enables interconnection between the first memory module 100-1 and the second memory module 100-2 and one or more circuits on the motherboard 202.

The direction of the airflow 110 from a fan (not shown) in the computer system is through the channel 204 between the first memory module 100-1 and the second memory module 100-2. The first memory module 100-1 and the second memory module 100-2 that are mounted on the motherboard 202 such that they are parallel to each other.

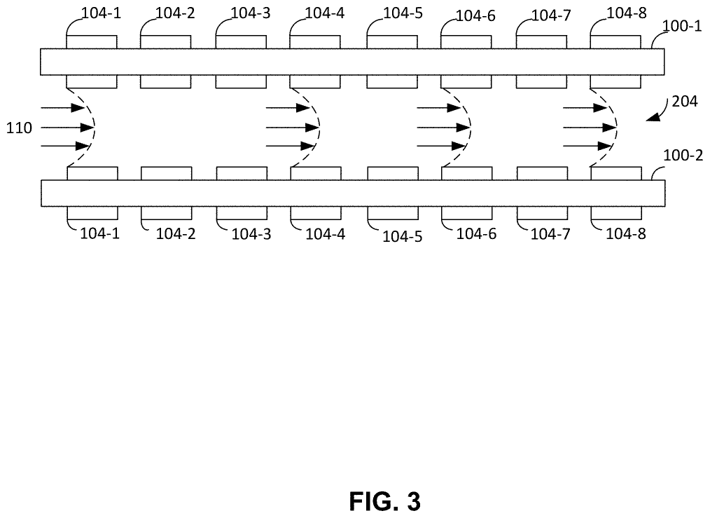

FIG. 3 is a top view of the channel 204 between the first memory module 100-1 and the second memory module 100-2 shown in FIG. 2.

The airflow 110 through the channel 204 cools the memory integrated circuits 104-1, . . . 104-8 on each of the first memory module 100-1 and the second memory module 100-2. The memory integrated circuit 104-1 on each of the first memory module 100-1 and the second memory module 100-2 closest to the source of the airflow 110 has a lower temperature than the memory integrated circuit 104-8 on each of the first memory module 100-1 and the second memory module 100-2 furthest from the source of the airflow 110.

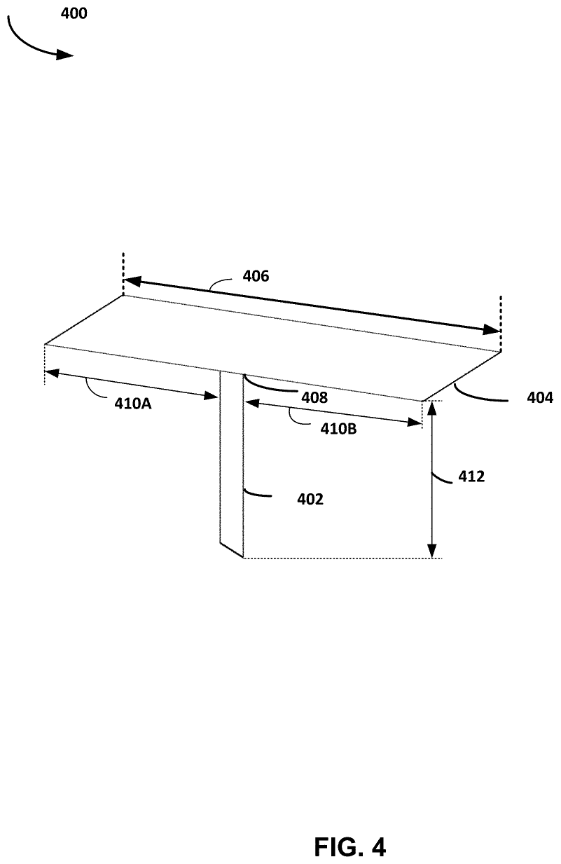

FIG. 4 is a side view of a channel structure 400 that includes a horizontal support member 404 and a flow enhancing structure 402 that extends a length 412 from the top of the memory module 100 into a channel 204 between a first memory module 100-1 and a second memory module 100-2. The flow enhancing structure 402 is placed near a memory integrated circuit 404-1, . . . 404-8 at the end of memory module 100 that is furthest from the source of the airflow 110. The flow enhancing structure 402 has one end 408 connected to the horizontal support member 404.

The length 406 of the horizontal support member 404 is dependent on the width of the channel between the first memory module 100-1 and the second memory module 100-2. The horizontal support member 404 is coupled to the top of the first memory module 100-1 and the second memory module 100-2, for example, through means of an adhesive or via the weight of a top of an enclosure of a computer system in which the memory modules and motherboard 202 are installed.

The flow enhancing structure 402 is a first distance 410A from a first end of the horizontal support member 404 and a second distance 410B from a second end of the horizontal support member 404. In an embodiment, the first distance 410A and second distance 410B are selected such that the flow enhancing structure 402 is in the center of the channel 204.

The shape and placement of the flow enhancing structure 402 in the channel 204 is selected such that that there is a minimal increase in impedance while also having the maximum heat transfer from the memory integrated circuit that operates at the highest temperature. In an embodiment, a flow enhancing structure 402 placed at the leading edge of the memory integrated circuit with the highest temperature on the memory module 100 provides a good heat transfer to impedance ratio. In other embodiments, the flow enhancing structure 402 can be a different shape and placed in different positions along the length of the memory module 100.

To minimize the increase of impedance in the system, the size of the flow enhancing structure 402 is selected to be as small as possible to reduce the temperature of the memory integrated circuit 404-1, . . . 404-8 sufficiently to increase the cooling capability of the memory module 100. The flow enhancing structure 402 can be referred to as a vertical pin. In an embodiment, the channel 204 is 0.35 inches (8.89 millimeters (mm)), the length 412 of the flow enhancing structure 402 is 24 mm and the radius of the cylindrical flow enhancing structure 402 is 0.5 mm.

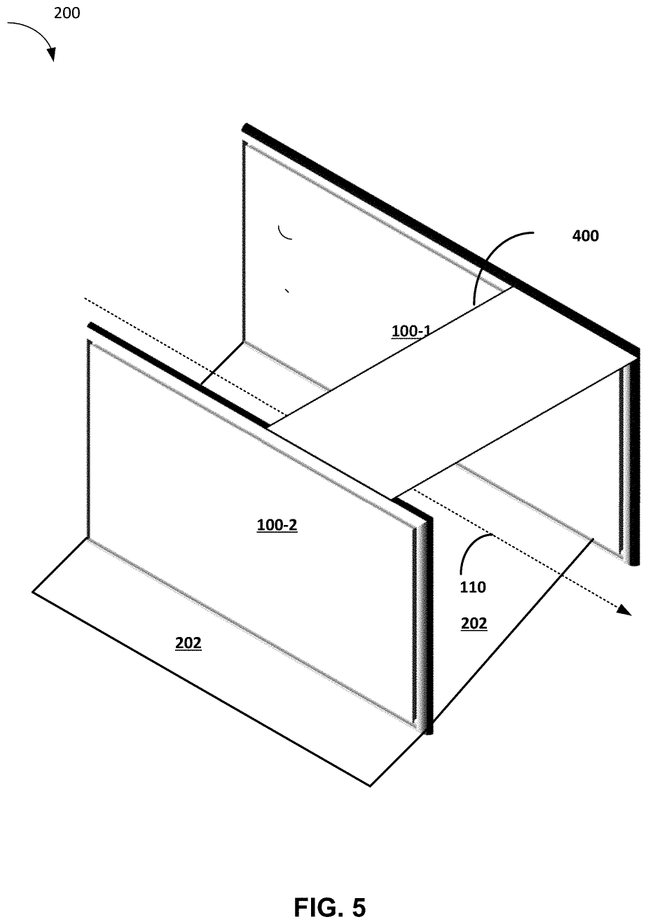

FIG. 5 illustrates placement of the channel structure 400 in the channel 204 between the first memory module 100-1 and the second memory module 100-2 shown in FIG. 2.

The width of the horizontal support member 404 is selected so that one end of the horizontal support member 404 can be placed on the top of the first memory module 100-1 and the other end of the horizontal support member 404 can be placed on the top of the second memory module 100-2 such that the flow enhancing structure 402 extends vertically into the channel 204 between the first memory module 100-1 and the second memory module 100-2.

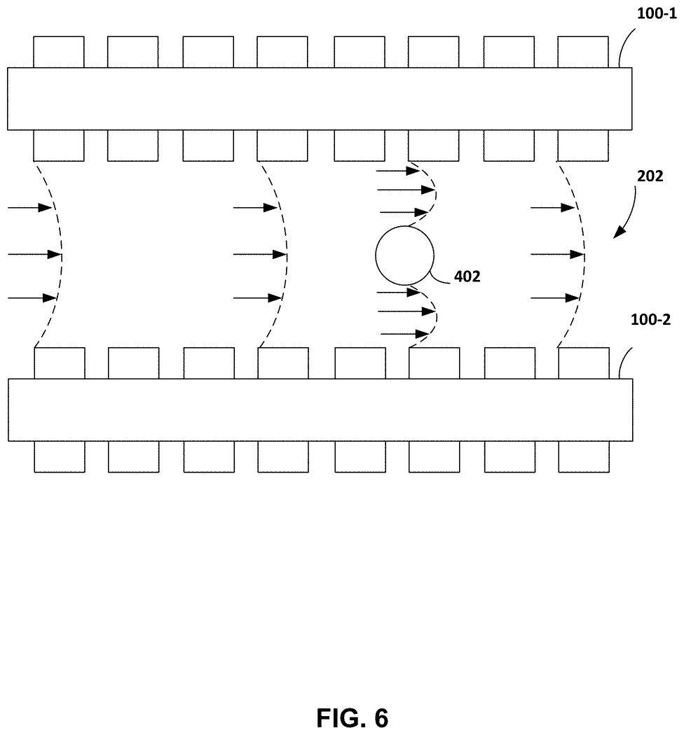

FIG. 6 is a top view of the channel 204 between the first memory module 100-1 and the second memory module 100-2 shown in FIG. 2 that includes the flow enhancing structure 402.

In the embodiment shown, the flow enhancing structure 402 is a cylinder. The flow enhancing structure 402 is placed near one of the memory integrated circuits 104-1, . . . 104-8 on the memory module 100, that are at the end of the memory module 100 furthest from the source of the airflow. The memory integrated circuits 104-1, . . . 104-8 furthest from the source of the airflow operate at higher temperatures than the memory integrated circuits 104-1, . . . 104-8 on the memory module 100 that are closer to the source of the airflow 110. The flow enhancing structure 402 disrupts the ai flow at that spot, making the airflow 110 more turbulent and faster to increase heat transfer from the memory integrated circuits that operate at the higher temperature.

The disruption of the airflow boundary layer at the memory integrated circuits that are further from the source of the airflow (that is, the memory integrated circuits on the memory module 100 that have the higher temperatures) to spot-increase the heat transfer coefficient there. Placing the flow enhancing structure 402 in the channel 204 at a section of the memory module 100 in which the memory integrated circuits are further from the source of the airflow increases the airspeed significantly in that section of the memory module 100.

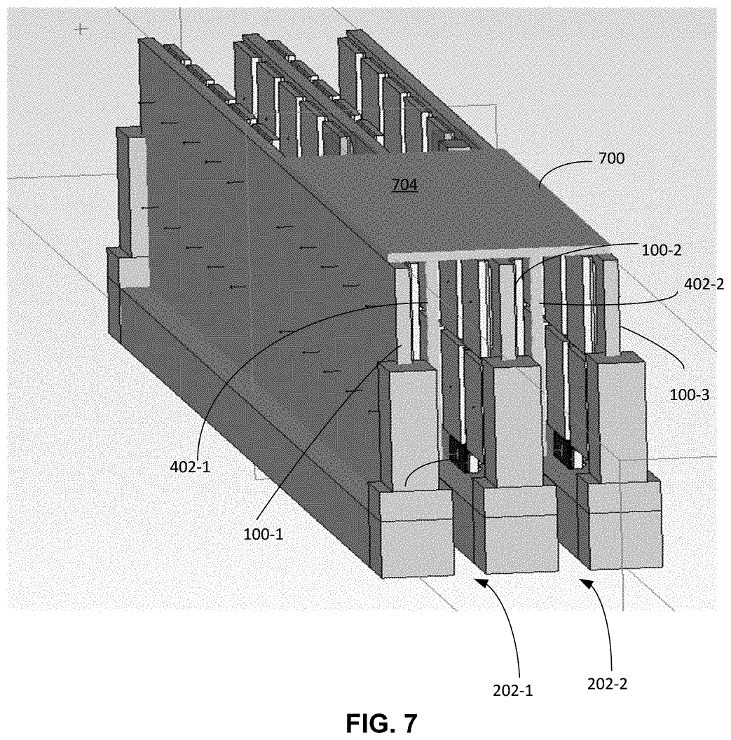

FIG. 7 illustrates another embodiment of channel structure 700 in a system having a plurality of memory modules. The system has three memory modules, the first memory module 100-1, the second memory module 100-2 and a third memory module 100-3. The channel structure 700 includes a horizontal support member 704 that extends from the top of the first memory module 100-1 to the third memory module 100-3.

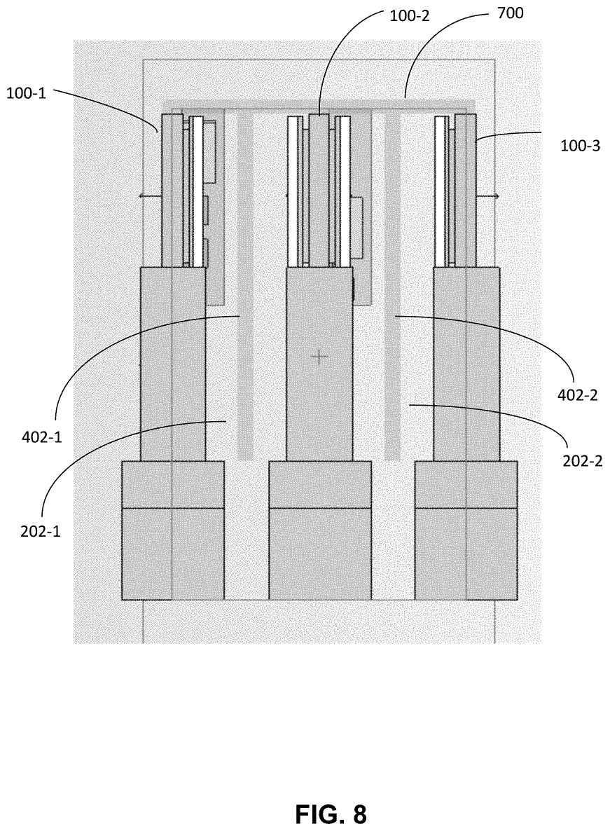

FIG. 8 illustrates a side view of the channel structure 700 shown in FIG. 7. A first flow enhancing structure 402-1 extends vertically into the first channel 202-1 between the first memory module 100-1 and the second memory module 100-2. A second flow enhancing structure 402-2 extends vertically into the second channel 202-2 between the second memory module 100-2 and the third memory module 100-3.

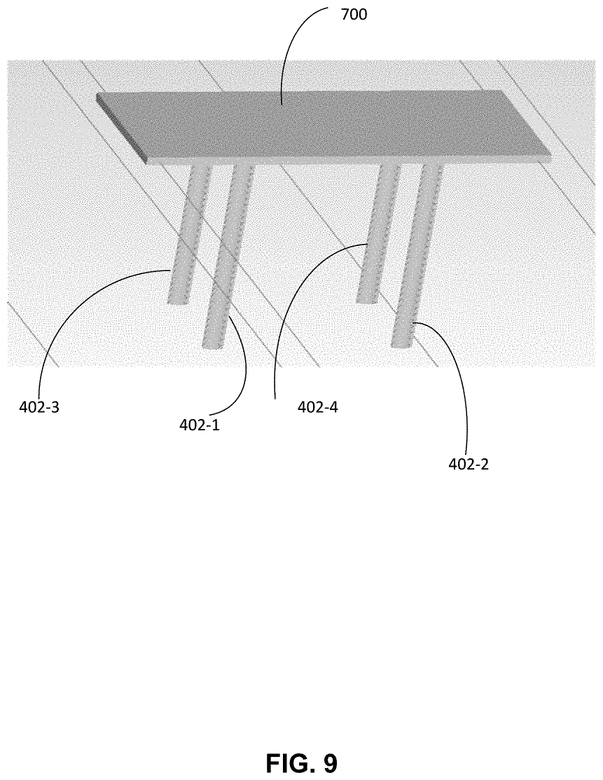

FIG. 9 is as an end view of the channel structure 700 shown in FIG. 7. The channel structure 700 has four flow enhancing structures 402-1, 402-2, 402-3, 402-4 that extend vertically into channels. The first flow enhancing structure 402-1 and a third flow enhancing structure enhancing structure extend vertically into the first channel 202-1 between the first memory module 100-1 and the second memory module 100-2. The second flow enhancing structure 402-2 and a fourth flow enhancing structure 402-4 extend vertically into the second channel 202-2 between the second memory module 100-2 and the third memory module 100-3. In an embodiment, the first flow enhancing structure 402-1 and the third flow enhancing structure 402-3 are about 10 millimeters (mm) apart in the first channel 202-1 and the second flow enhancing structure 402-2 and the fourth flow enhancing structure 402-4 are about 10 millimeters (mm) apart in the second channel 202-2.

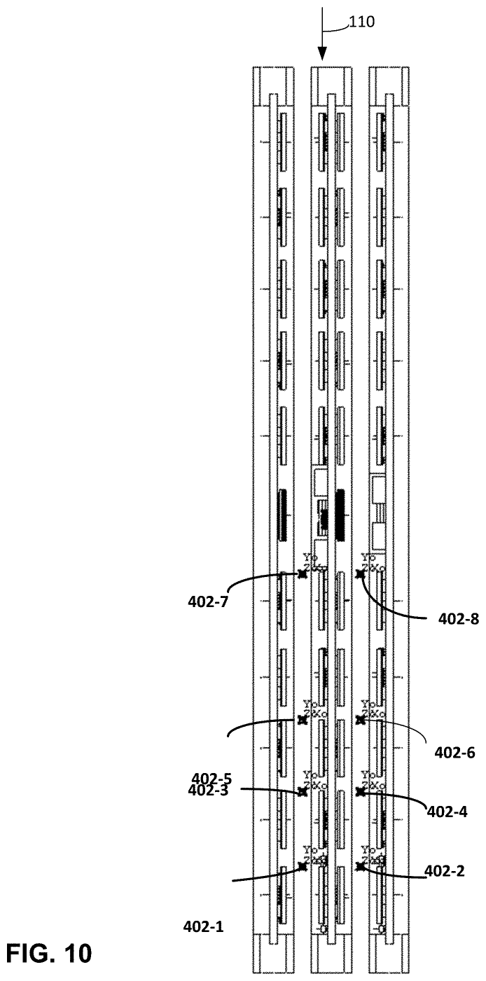

FIG. 10 is a top view of the channel structure illustrating position of the flow enhancing structures 402-1, 402-2, 402-3, 402-4 in channels 202-1, 202-2 between the memory modules shown in FIG. 7.

Cooling capacity in the embodiment with four flow enhancing structures 402-1, 402-2, 402-3, 402-4, two flow enhancing structures per channel 202-1, 202-2 is increased from 21.8 Watts to 23.1 Watts, the maximum temperature of a memory integrated circuit on the memory module 100 decreases by 4.3° C. and the total airspeed of the channel decreases by about 0.5 meters per second (m/s). Additional flow enhancement structures 402-5, 402-6, 402-7, 402-8 can be added to further reduce the maximum temperature of a memory integrated circuit on the memory modules 100-1, 100-2, 100-3.

An embodiment has been described for a flow enhancing structure that extends vertically into a channel between memory modules (DIMM) with a plurality of memory integrated circuits (DRAM). The flow enhancing structure can be used in any channel between any two daughter cards coupled to a motherboard. For example, the daughter cards can be a solid state drives. The memory module can be a SO-DIMM (small outline dual in-line memory module). The memory integrated circuits can be non-volatile memory. The memory module can include non-volatile memory integrated circuits and volatile memory integrated circuits.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Tri-Level Cell (“TLC”), Quad-Level Cell (“QLC”), Penta-Level Cell (PLC) or some other NAND). A NVM device can also include a byte-addressable, write-in-place three dimensional Crosspoint memory device, or other byte addressable write-in-place NVM devices (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

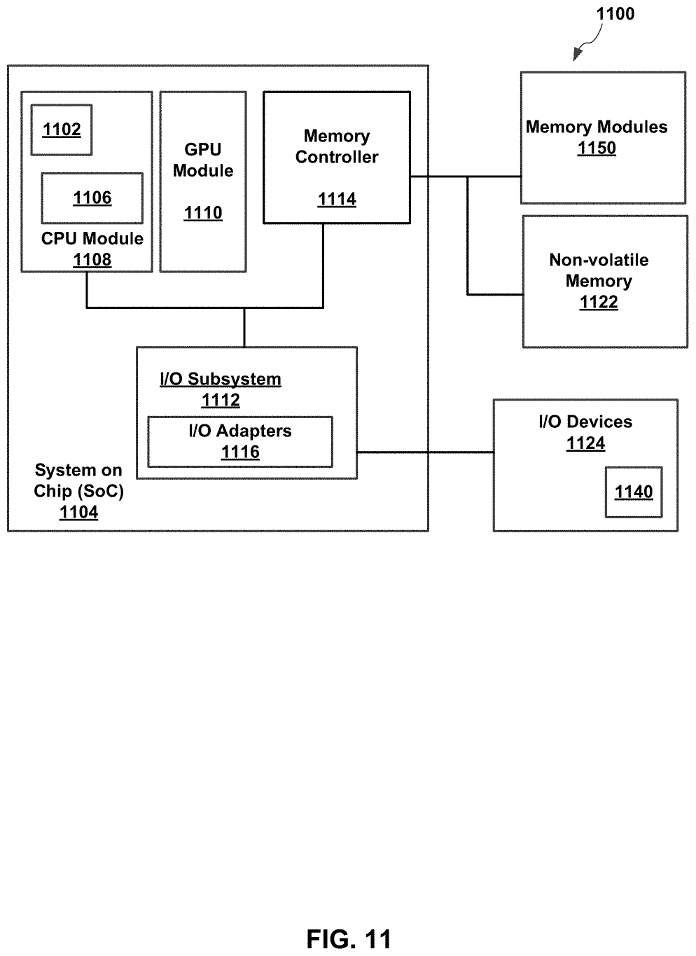

FIG. 11 is a block diagram of an embodiment of a computer system 1100 that includes a plurality of memory modules 1150. Computer system 1100 can correspond to a computing device including, but not limited to, a server, a workstation computer, a desktop computer, a laptop computer, and/or a tablet computer.

The computer system 1100 includes a system on chip (SOC or SoC) 1104 which combines processor, graphics, memory, and Input/Output (I/O) control logic into one SoC package. The SoC 1104 includes at least one Central Processing Unit (CPU) module 1108, a memory controller 1114, and a Graphics Processor Unit (GPU) 1110. In other embodiments, the memory controller 1114 can be external to the SoC 1104. The CPU module 1108 includes at least one processor core 1102, and a level 2 (L2) cache 1106.

Although not shown, each of the processor core(s) 1102 can internally include one or more instruction/data caches, execution units, prefetch buffers, instruction queues, branch address calculation units, instruction decoders, floating point units, retirement units, etc. The CPU module 1108 can correspond to a single core or a multi-core general purpose processor, such as those provided by Intel® Corporation, according to one embodiment.

The Graphics Processor Unit (GPU) 1110 can include one or more GPU cores and a GPU cache which can store graphics related data for the GPU core. The GPU core can internally include one or more execution units and one or more instruction and data caches. Additionally, the Graphics Processor Unit (GPU) 1110 can contain other graphics logic units that are not shown in FIG. 11, such as one or more vertex processing units, rasterization units, media processing units, and codecs.

Within the I/O subsystem 1112, one or more I/O adapter(s) 1116 are present to translate a host communication protocol utilized within the processor core(s) 1102 to a protocol compatible with particular I/O devices. Some of the protocols that adapters can be utilized for translation include Peripheral Component Interconnect (PCI)-Express (PCIe); Universal Serial Bus (USB); Serial Advanced Technology Attachment (SATA) and Institute of Electrical and Electronics Engineers (IEEE) 1594 “Firewire”.

The I/O adapter(s) 1116 can communicate with external I/O devices 1124 which can include, for example, user interface device(s) including a display and/or a touch-screen display 1140, printer, keypad, keyboard, communication logic, wired and/or wireless, storage device(s) including hard disk drives (“HDD”), solid-state drives (“SSD”), removable storage media, Digital Video Disk (DVD) drive, Compact Disk (CD) drive, Redundant Array of Independent Disks (RAID), tape drive or other storage device. The storage devices can be communicatively and/or physically coupled together through one or more buses using one or more of a variety of protocols including, but not limited to, SAS (Serial Attached SCSI (Small Computer System Interface)), PCIe (Peripheral Component Interconnect Express), NVMe (NVM Express) over PCIe (Peripheral Component Interconnect Express), and SATA (Serial ATA (Advanced Technology Attachment)). The display and/or a touch-screen display 1140 can be communicatively coupled to the processor in the SoC 1104 to display data stored in the DRAM devices in the memory module 1150.

Additionally, there can be one or more wireless protocol I/O adapters. Examples of wireless protocols, among others, are used in personal area networks, such as IEEE 802.15 and Bluetooth, 4.0; wireless local area networks, such as IEEE 802.11-based wireless protocols; and cellular protocols.

The memory controller 1114 can also be coupled to non-volatile memory 1122. A non-volatile memory device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also include a byte-addressable write-in-place three dimensional crosspoint memory device, or other byte addressable write-in-place NVM devices (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

Flow diagrams as illustrated herein provide examples of sequences of various process actions. The flow diagrams can indicate operations to be executed by a software or firmware routine, as well as physical operations. In one embodiment, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood as an example, and the process can be performed in a different order, and some actions can be performed in parallel. Additionally, one or more actions can be omitted in various embodiments; thus, not all actions are required in every embodiment. Other process flows are possible.

To the extent various operations or functions are described herein, they can be described or defined as software code, instructions, configuration, and/or data. The content can be directly executable (“object” or “executable” form), source code, or difference code (“delta” or “patch” code). The software content of the embodiments described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to the disclosed embodiments and implementations of the invention without departing from their scope.

Therefore, the illustrations and examples herein should be construed in an illustrative, and not a restrictive sense. The scope of the invention should be measured solely by reference to the claims that follow.

What is claimed is:

1. A memory subsystem comprising:
a channel structure, the channel structure comprising:
a horizontal support member; and
a flow enhancing structure, the flow enhancing structure having one end connected to the horizontal support member; and
at least two memory modules, a first memory module and a second memory module, each of the first memory module and the second memory module comprising a plurality of memory integrated circuits, the horizontal support member to extend from a top of the first memory module to the top of the second memory module, the other end of the flow enhancing structure to extend into a memory module channel between the first memory module and the second memory module, the flow enhancing structure to disrupt airflow through the memory module channel to increase heat transfer from a first memory integrated circuit near the flow enhancing structure.

2. The memory subsystem of claim 1, wherein the first memory integrated circuit has a higher temperature than another of the plurality of memory integrated circuits closer to a source of the airflow.

3. The memory subsystem of claim 2, wherein the memory modules are dual in-line memory modules and the memory integrated circuits are a Dynamic Random Access Memory.

4. The memory subsystem of claim 1, wherein the flow enhancing structure is a cylinder.

5. The memory subsystem of claim 1, wherein the flow enhancing structure is in the center of the memory module channel.

6. The memory subsystem of claim 1, the channel structure comprising a second a flow enhancing structure to extend into the memory module channel between the first memory module and the second memory module.

7. The memory subsystem of claim 1, comprising a third memory module, the horizontal support member to extend from the top of the first memory module to the top of the third memory module.

8. The memory subsystem of claim 1, wherein the memory integrated circuits are a non-volatile memory.

9. A system comprising:
a memory subsystem comprising
a channel structure, the channel structure comprising:
a horizontal support member; and
a flow enhancing structure, the flow enhancing structure having one end connected to the horizontal support member; and
at least two memory modules, a first memory module and a second memory module, each of the first memory module and the second memory module comprising a plurality of memory integrated circuits, the horizontal support member to extend from a top of the first memory module to the top of the second memory module, the other end of the flow enhancing structure to extend into a memory module channel between the first memory module and the second memory module, the flow enhancing structure to disrupt airflow through the memory module channel to increase heat transfer from a first memory integrated circuit near the flow enhancing structure; and
a display communicatively coupled to a processor to display data stored in the memory integrated circuits.

10. The memory subsystem of claim 9, wherein the first memory integrated circuit has a higher temperature than another of the plurality of memory integrated circuits closer to a source of the airflow.

11. The memory subsystem of claim 10, wherein the memory modules are dual in-line memory modules and the memory integrated circuits are Dynamic Random Access Memory.

12. The memory subsystem of claim 9, wherein the flow enhancing structure is a cylinder.

13. The memory subsystem of claim 9, wherein the flow enhancing structure is in the center of the memory module channel.

14. The memory subsystem of claim 9, the channel structure comprising a second a flow enhancing structure to extend into the memory module channel between the first memory module and the second memory module.

15. The memory subsystem of claim 9, comprising a third memory module, the horizontal support member to extend from the top of the first memory module to the top of the third memory module.

16. The memory subsystem of claim 9, wherein the memory integrated circuits are non-volatile memory.
